(19) United States
(12) Patent Application Publication
(10) Pub. No.: US 2013/0089759 A1
(43) Pub. Date: Apr. 11, 2013

(54) RECHARGEABLE BATTERY

(71) Applicants: Min-Yeol Han, Yongin-si (KR); Seok-Yoon Yoo, Yongin-si (KR); Hae-Kwon Yoon, Yongin-si (KR)

(72) Inventors: Min-Yeol Han, Yongin-si (KR); Seok-Yoon Yoo, Yongin-si (KR); Hae-Kwon Yoon, Yongin-si (KR)

(21) Appl. No.: 13/421,793

(22) Filed: Mar. 15, 2012

(30) Foreign Application Priority Data
Oct. 11, 2011 (KR) 10-2011-0103677

(51) Int. Cl. H01M 2/00; H01M 2/30; H01M 2/02

(52) U.S. Cl. 429/61

(57) ABSTRACT

A rechargeable battery according to an exemplary embodiment includes: an electrode assembly having a first electrode, a separator, and a second electrode that are layered; a case in which the electrode assembly is installed; a cap plate coupled to an opening of the case; a first electrode terminal provided in the cap plate to electrically connect the cap plate and the first electrode; a second electrode terminal provided in the cap plate, electrically insulated from the cap plate, and electrically connected to the second electrode; and an external short-circuit portion including a short-circuit tab and provided between the second electrode terminal and the cap plate. The short-circuit tab is formed of a heterogeneous metal.

### CROSS-REFERENCE TO RELATED APPLICATION

This application claims priority to and the benefit of Korean Patent Application No. 10-2011-0103677, filed in the Korean Intellectual Property Office on Oct. 11, 2011, the entire content of which is incorporated herein by reference.

### BACKGROUND

1. Field

The following description described technology relating to a rechargeable battery.

2. Description of the Related Art

Unlike a primary battery, a rechargeable battery is a battery that can be repetitively charged and discharged. Low-capacity rechargeable batteries may be used for portable compact electronic apparatuses such as mobile phones or notebook computers and camcorders, and high-capacity rechargeable batteries may be used as a power supply for driving a motor of a hybrid vehicle, an electric vehicle, etc.

In particular and as an example, a rechargeable battery includes an electrode assembly provided with positive and negative electrodes with a separator therebetween, a case receiving the electrode assembly, a cap plate coupled to an opening of the case, and positive and negative terminals provided in the cap plate and connected to the positive and negative electrodes through positive and negative lead tabs.

The negative terminal is formed with an electric insulation structure in the cap plate, and the positive terminal is connected via a conductive structure with the cap plate and thus the cap plate becomes positive. In this case, when an internal pressure is increased due to an overcharge, the rechargeable battery may have an external short-circuit portion that short-circuits the negative terminal and the cap plate from the outside. When the external short-circuit occurs, the fuse melts due to an overcurrent and thus electric connection between the electrode assembly and the negative terminal is blocked.

However, when the current is blocked due to the external short-circuit and melting of the fuse, a current flows from the positive terminal to the negative terminal via the cap plate and the external short-circuit portion in the short-circuit state. When the current continuously flows through such a path, the electrode assembly is continuously thermally damaged due to Joule heat.

The above information disclosed in this Background section is only for enhancement of understanding of the background of the described technology and therefore it may contain information that does not form the prior art that is already known in this country to a person of ordinary skill in the art.

### SUMMARY

An aspect of an embodiment of the described technology is directed toward a rechargeable battery that can prevent thermal damage to an electrode assembly by releasing an external short-circuit after the external short-circuit has occurred.

A rechargeable battery according to an exemplary embodiment includes: an electrode assembly having a first electrode, a second electrode, and a separator between the first electrode and the second electrode; a case housing the electrode assembly; a cap plate coupled to an opening of the case; a first electrode terminal in the cap plate and electrically connected with the cap plate and the first electrode; a second electrode terminal in the cap plate, electrically insulated from the cap plate (e.g., provided in an insulated manner), and electrically connected to the second electrode; and an external short-circuit portion between the second electrode terminal and the cap plate. The external short-circuit portion includes a short-circuit tab connected to the second electrode terminal, and a short-circuit member in a short-circuit hole of the cap plate, facing the short-circuit tab and configured to be bonded to or separated from the short-circuit tab according to an internal pressure. The short-circuit tab is formed of a heterogeneous metal.

The heterogeneous metal of the short-circuit tab may include: a first metal plate, having a high thermal expansion coefficient, facing the short-circuit member; and a second metal plate, having a low thermal expansion coefficient, facing oppositely away from the short-circuit member.

The rechargeable battery according to the exemplary embodiment may further include an insulation member disposed between the short-circuit tab and the cap plate.

The insulation member may include a bottom portion supporting the short-circuit tab and a frame portion exposing the upper surface of the short-circuit tab, the frame portion protruding from the bottom portion and surrounding a side surface of the short-circuit tab.

The frame portion may be opened at its side in a length direction of the cap plate.

The short-circuit tab and the frame portion may form a first gap separated therebetween in a width direction of the cap plate.

The short-circuit tab and the frame portion may form a second gap separated therebetween in a length direction of the cap plate.

The rechargeable battery may further include a current collecting lead tab electrically connecting the second electrode terminal and the second electrode, and the current collecting lead tab may form a fuse having a width that is smaller than a lead tab width of the current collecting lead tab set along a width direction of the cap plate.

The first metal plate and the second plate of the short-circuit tab may respectively have thermal expansion coefficients such that the short-circuit tab attached to the short-circuit member may be separated from the short-circuit member after melting of the fuse.

The heterogeneous metal of the short-circuit tab may be a bi-metal.

As described, according to the exemplary embodiment, the short-circuit tab of the external short-circuit portion is formed of a heterogeneous metal and thus external short-circuit can be released by separating the short-circuit tab from the short-circuit member when external short-circuit occurs, to thereby prevent (or protect from) thermal damage to the electrode assembly due to Joule heat after the external short-circuit.

### BRIEF DESCRIPTION OF THE DRAWINGS

FIG. 1 is a perspective view of a rechargeable battery according to an exemplary embodiment.

FIG. 2 is a cross-sectional view of FIG. 1, taken along the line II-II.

FIG. 3 is a side view of a connected state of a positive current collecting lead tab and an electrode assembly.

FIG. 4 is an exploded perspective view of a negative current collecting lead tab and the electrode assembly.

FIGS. 5a, 5b, and 5c are cross-sectional views sequentially showing an operation state of an external short-circuit portion.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

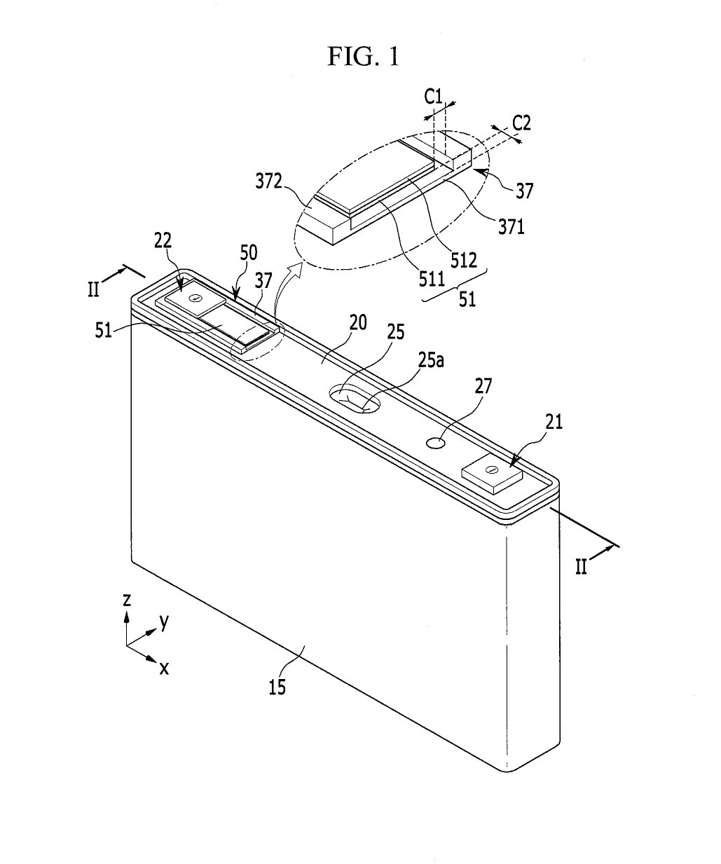

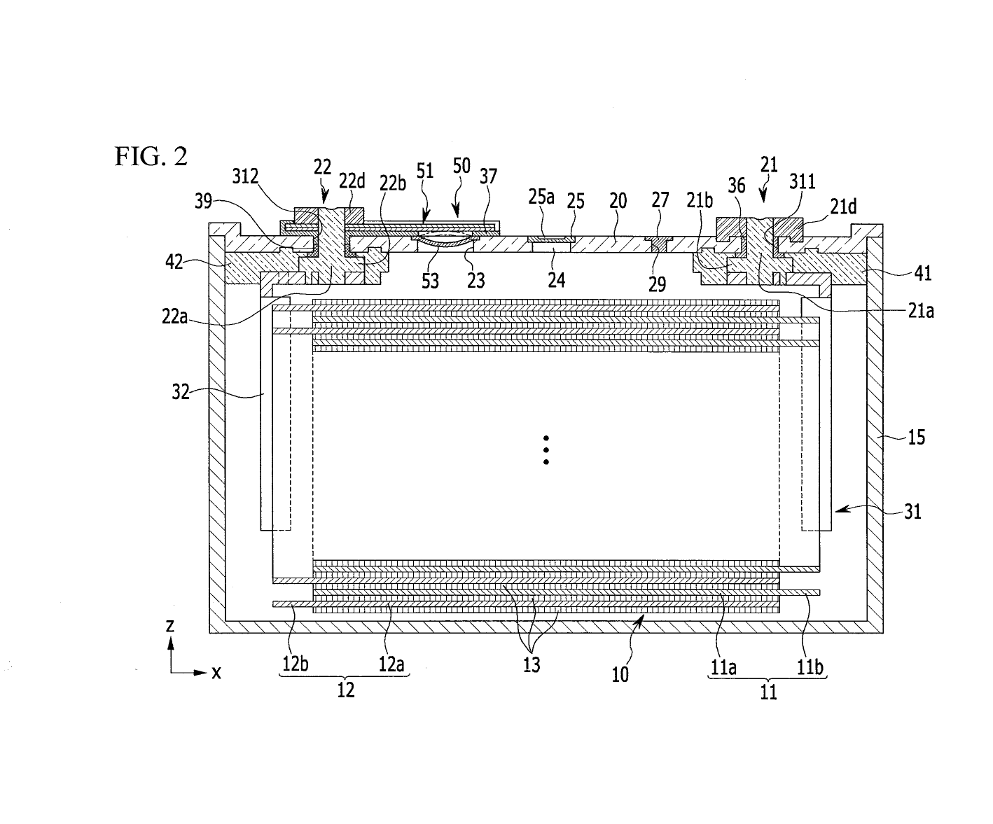

FIG. 1 is a perspective view of a rechargeable battery according to an exemplary embodiment, and FIG. 2 is a cross-sectional of FIG. 1, taken along the line II-II. Referring to FIG. 1 and FIG. 2, the rechargeable battery according to the exemplary embodiment includes an electrode assembly 10 for charging and discharging a current, a case 15 in which the electrode assembly 10 is installed, a cap plate 20 coupled to an opening of the case 15, a first electrode terminal (hereinafter, referred to as a positive terminal) 21 installed in the cap plate 20, and a second electrode terminal (hereinafter, referred to as a negative terminal) 22 installed in the cap plate 20.

For example, the electrode assembly 10 is formed by disposing a first electrode (hereinafter, referred to as a positive electrode) 11 and a second electrode (hereinafter, referred to as a negative electrode) 12 at both sides of a separator (e.g., an electrical insulator) 13 and spirally winding the positive electrode 11, the separator 13, and the negative electrode 12 into a jelly roll shape (state).

Further, the electrode assembly may be assembled by layering a positive electrode and a negative electrode that are each formed of a single plate and interposing a separator therebetween; or may be formed by folding a positive electrode, a separator, and a negative electrode in a zigzag manner and then layering the same (not shown).

The positive and negative electrodes 11 and 12, respectively, include coated regions 11a and 12a (where an active material is coated to a current collector formed of a metal plate), and uncoated regions 11b and 12b (where the current collector is exposed because of not being coated with the active material). For example, the current collector of the positive electrode 11 is formed of an aluminum thin film, and the current collector of the negative electrode 12 is formed of a copper thin film.

The uncoated region 11b of the positive electrode 11 is formed at one end of the positive electrode 11 along the spirally wound positive electrode 11. The uncoated region 12b of the negative electrode 12 is formed at one end of the negative electrode 12 along the spirally wound negative electrode 12. That is, the uncoated regions 11b and 12b are respectively disposed at both ends of the electrode assembly 10 such that they enable electric connection of the positive and negative terminals 21 and 22 to the electrode assembly 10.

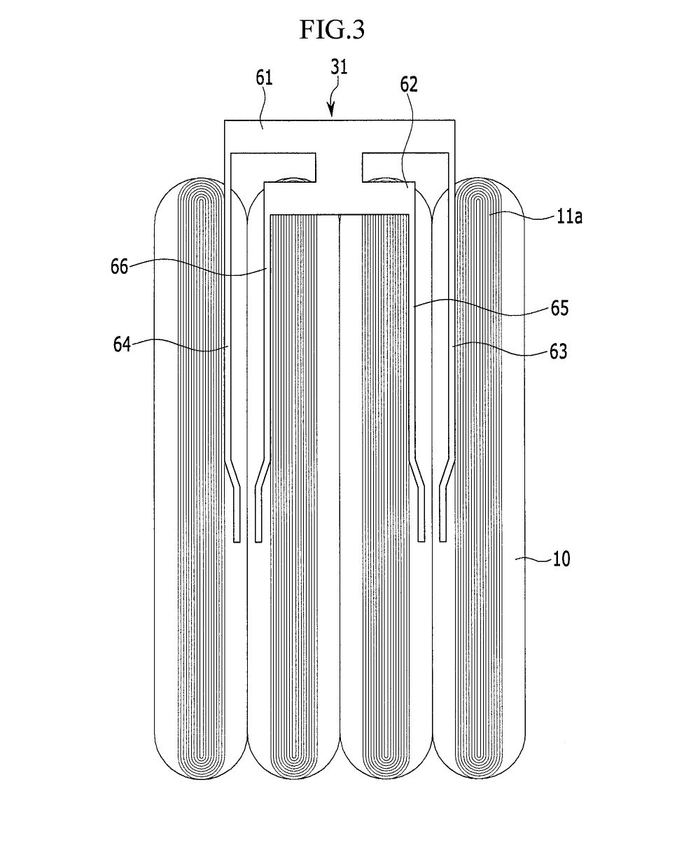

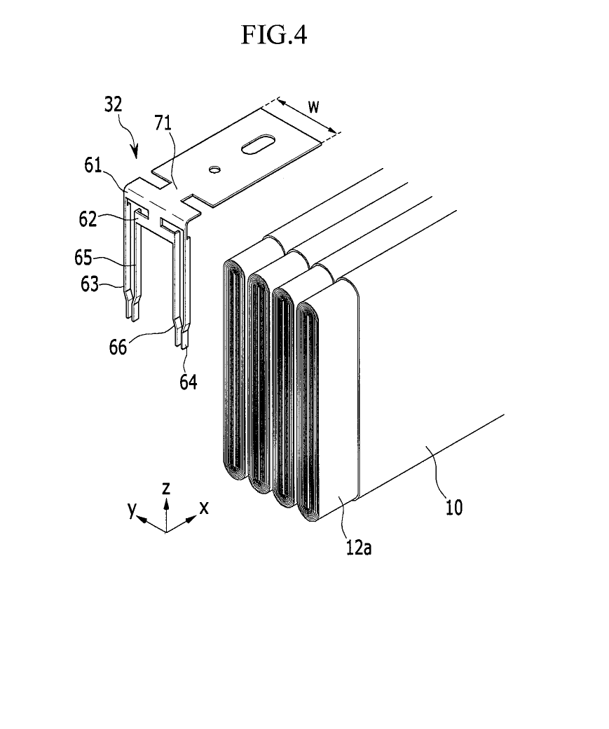

FIG. 3 is a side view of a connection state of the positive current collecting lead tab 31 and the electrode assembly 10, and FIG. 4 is an exploded perspective view of the negative current collecting lead tab 32 and the electrode assembly 10. Referring to FIG. 3 and FIG. 4, the electrode assembly 10 may be formed in plural.

In the electrode assemblies 10, the respective positive electrodes 11 are electrically connected through a positive current collecting lead tab 31 (refer to FIG. 2 and FIG. 3), and the respective negative electrodes 12 are electrically connected through a negative current collecting lead tab 32 (refer to FIG. 2 and FIG. 4). Also, the present invention may be applied to a rechargeable battery having a single electrode assembly.

Referring back to FIG. 1 and FIG. 2, the case 15 is formed in the shape of a cuboid to set a space for receiving the electrode assemblies 10 and electrolyte solution in the case 15, and an opening is formed in one side of the cuboid for connection between the outside and the inside of the case 15. The opening enables insertion of the electrode assembly 10 into the case 15.

The cap plate 20 is coupled to the opening of the case 15 to form a closed receiving space with the case 15. For example, the case 15 and the cap plate 20 are formed of aluminum, and in this case, they can have an excellent welding property by having the same material when they are coupled and then welded to each other.

The cap plate 20 includes an electrolyte injection opening 29 and a vent hole 24. The electrolyte injection opening 29 enables insertion of the electrolyte solution into the case 15 after coupling the cap plate 20 to the case 15. After the insertion of the electrolyte solution, the electrolyte injection opening 29 is sealed by a sealing cap 27.

The vent hole 24 is closed and sealed by a vent plate 25 so as to prevent (protect from) explosion of the rechargeable battery by discharging internal gas generated from the charging and discharging of the electrode assembly 10 to the outside of the rechargeable battery. When the internal pressure of the rechargeable battery reaches a set or predetermined level, the vent plate 25 is ruptured, and a notch 25a may be formed in the vent plate 25 to induce a rupture of the vent plate 34.

Also, the rechargeable battery according to the exemplary embodiment includes an external short-circuit portion 50 provided with (or in) the negative terminal 22 so as to short-circuit the positive electrode 11 and the negative electrode 12 of the electrode assembly 10 from the outside of the case 15 when the internal pressure of the rechargeable battery is increased due to over-charging. For example, the external short-circuit portion 50 includes a short-circuit tab 51 and a short-circuit member 53 that are maintained at a separated state or attached to each other according to the internal pressure.

The short-circuit tab 51 is electrically connected to the negative terminal 22, and the short-circuit member 53 is provided in a short-circuit hole 23 of the cap plate 20 arranged facing the short-circuit tab 51. Since the cap plate 20 is connected to the positive terminal 21, the short-circuit member 53 is electrically connected to the positive terminal 21. In addition, the short-circuit tab 51 and the short-circuit member 53 are electrically insulated from each other by an insulation member 37 disposed between the short-circuit tab 51 and the cap plate 20 and maintain a spatial distance therebetween.

The positive and negative terminals 21 and 22 are formed penetrating the cap plate 20 and electrically connected to the electrode assembly 10. That is, the positive and negative terminals 21 and 22 are respectively electrically connected to the positive electrode 11 and the negative electrode 12 of the electrode assembly 10 and thus they draw out the electrical power of the electrode assembly 10 to the outside of the electrode assembly 10.

The positive and negative terminals 21 and 22 respectively include rivet terminals 21a and 22a provided in terminal holes 311 and 312 formed in the cap plate 20, flanges 21b and 22b formed in the rivet terminals 21a and 22a in the inner side of the case 15, and plate terminals 21d and 22d disposed in the outer side of the case 15 and thus coupled to the rivet terminals 21a and 22a.

When manufacturing a module, the plate terminals 21d and 22d are connected to plate terminals (not shown) of neighboring rechargeable batteries through a bus bar (not shown) so that the rechargeable batteries can be coupled in series or parallel.

In the positive terminal 21, a positive gasket 36 is provided between the rivet terminal 21a and the inner side of the terminal hole 311 to seal the rivet terminal 21a and the terminal hole 311. The positive gasket 36 is further extended between the flange 21b and the cap plate 20 to further seal the flange 21b and the cap plate 20. That is, the positive gasket 36 prevents (protects from) leakage of electrolyte solution through the terminal hole 311 by being installed with the positive terminal 21 in the cap plate 20.

In the negative terminal 22, a negative gasket 39 is provided between the rivet terminal 22a and the terminal hole 312 to seal the rivet terminal 22a and the terminal hole 312. The negative gasket 39 is extended between the flange 22b and the cap plate 20 to further seal the flange 22b and the cap plate 20. That is, the negative gasket 39 prevents (protects from) leakage of the electrolyte solution through the terminal hole 312 by being installed with the negative terminal 22 in the cap plate 20.

The positive and negative current collecting lead tabs 31 and 32 respectively electrically connect the positive and negative terminals 21 and 22 to the positive and negative electrodes 11 and 12 of the electrode assembly 10. That is, the positive and negative current collecting lead tabs 31 and 32 are coupled to lower ends of the rivet terminals 21a and 22a, the lower ends are calked, and the positive and negative current collecting lead tabs 31 and 32 are coupled to the lower ends of the rivet terminals 21a and 22a by being supported (and contacted) by the flanges 21b and 22b.

Positive and negative insulation members 41 and 42 are respectively provided between the positive and negative current collecting lead tabs 31 and 32 and the cap plate 20 for electric insulation therebetween.

As an example, referring back to FIG. 3 and FIG. 4, the positive and negative current collecting lead tabs 31 and 32 are connected to four electrode assemblies 10. That is, the positive and negative current collecting lead tabs 31 and 32 respectively include a first branch portion 61 connected to the positive and negative terminals 21 and 22, a second branch portion 62 connected to the first branch portion 61, and first, second, third, and fourth bonded portions 63, 64, 65, and 66 respectively connected to the uncoated regions 11b and 12b by being extended downward from the first and second branch portions 61 and 62 and inserted between the electrode assemblies 10.

As shown in FIG. 4, the negative current collecting lead tab 32 forms a fuse 71 having a width that is smaller than a lead tab width W set along a width direction (y-axis direction) of the cap plate. The fuse 71 can melt under an overcurrent state and thus blocks a current.

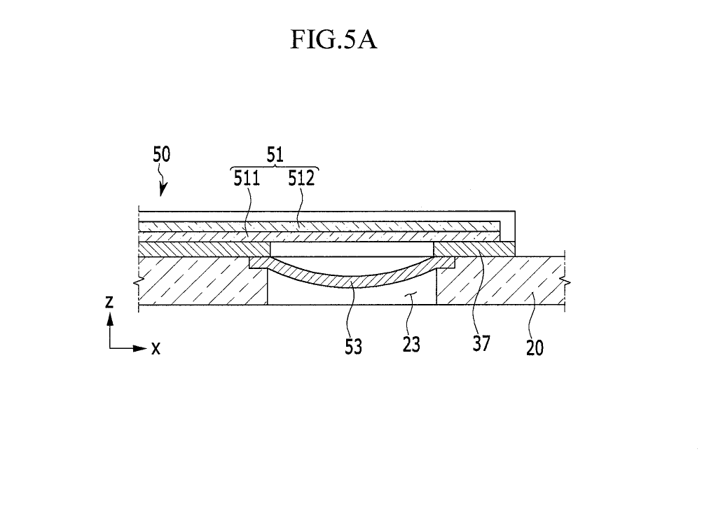

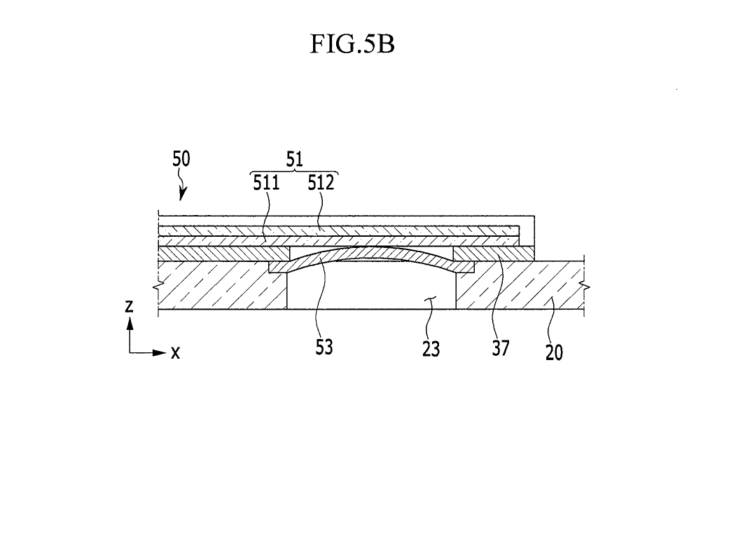

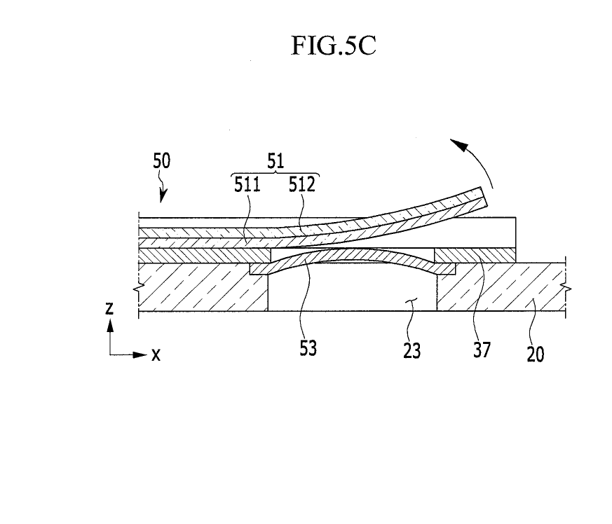

FIG. 5 is a cross-sectional view that sequentially shows an operation state of an external short-circuit portion 50. Referring to FIG. 1, FIG. 2, and FIGS. 5a, 5b, and 5c, the short-circuit member 53 in the normal state (FIG. 5a) is bonded to the short-circuit tab 51 due to increase of the internal pressure, a current of the electrode assembly 10 is discharged (FIG. 5b), and in this case, after the fuse 71 melts (or is melted) due to high current, the short-circuit state is released (FIG. 5c).

For example, the short-circuit tab 51 is formed of a heterogeneous metal. That is, the heterogeneous metal is formed of a first metal plate 511 and a second metal plate 512. The first metal plate 511 (having a first thermal expansion coefficient) is disposed to face the short-circuit member 53, and the second metal plate 512 (having a second thermal expansion coefficient) is disposed to face oppositely away from the short-circuit member 53. That is, the short-circuit tab 51 may be formed of a bi-metal. Since the first thermal expansion coefficient of the first metal plate 511 is higher than the second thermal expansion coefficient of the second metal plate 512, the short-circuit tab 51 is bent toward a direction separated from the short-circuit member 53 when the bi-metal is applied.

The short-circuit member 53 in the normal state (FIG. 5a) is bonded to the short-circuit tab 51 due to increase of the internal pressure, a current of the electrode assembly 10 is discharged (FIG. 5b), and in this case, after the fuse 71 melts due to high current, the short-circuit tab 51 can be separated from the short-circuit member 53 (FIG. 5c) by the first and second thermal expansion coefficient of the first and second metal plates 511 and 512. That is, the short-circuit tabs 51 of the first and second metal plates 511 and 512 maintain a contact state with the short-circuit member 53 from the external short-circuit, thereby melting the fuse 71 (FIG. 5b).

Meanwhile, the insulation member 37 supporting the short-circuit tab 51 is formed to not interrupt operation (operation to move upward in the z-axis direction) of the short-circuit tab 51 while electrically insulating the short-circuit tab 51 with respect to the short-circuit member 53 and the cap plate 20.

For example and referring also to FIG. 1, the insulation member 37 includes a bottom portion 371 supporting the short-circuit tab 51 and a frame portion 372 exposing (providing an opening at) the upper surface of the short-circuit tab 51 by being protruded from an outer side of the bottom portion 371 (FIG. 1) while surrounding the side surface of the short-circuit tab 51. Also, in one embodiment, the frame portion 372 is exposed (opened) at one of its sides in a length direction (x-axis direction) of the cap plate 20.

Further, the short-circuit tab 51 and the frame portion 372 form a first gap C1 separated therebetween in a width direction (y-axis direction) of the cap plate 20. The first gap C1 prevents (or protects from) friction interference between the side surface of the short-circuit tab 51 and inner surface of frame portion 372, facing the side surface when the short-circuit tab 51 is operated along the z-axis direction.

In addition, the short-circuit tab 51 and the frame portion 372 form a second gap C2 separated between end portions thereof in a length direction (x-axis direction) of the cap plate 20. The second gap C2 forms an insulation structure at the end portion of the short-circuit tab 51 while the short-circuit tab 51 and the short-circuit member 53 are separated in their normal state (FIG. 5a).

When an internal pressure of the rechargeable battery is increased and thus reaches a set or predetermined level, the short-circuit member 53 is inverted in the external short-circuit portion 50 and thus bonded to the short-circuit tab 51. Thus, a charged current of the electrode assembly 10 is discharged through the positive terminal 21, the cap plate 20, the short-circuit member 53, the short-circuit tab 51, the negative terminal 22, the fuse 71, and the electrode assembly 10. In this case, the fuse 71 melts due to the overcurrent and thus the negative terminal 22, and the electrode assembly 10 are electrically blocked (FIG. 5b).

After the fuse 71 is melted due to external short-circuit, a residual current of the electrode assembly 10 flows through the positive terminal 21, the cap plate 20, the short-circuit member 53, the short-circuit tab 51, and the negative terminal 22. The current is a high current and consistently flows, and the short-circuit tab 51 is then separated from the short-circuit member 53 due to bi-metal action of the short-circuit tab 51 caused by Joule heat. That is, the external short-circuit is released (FIG. 5c).

Therefore, no further current flow is formed between the positive and negative terminals 21 and 22, via the external short-circuit portion 50. After the melting of the fuse 71, Joule heat is no longer generated such that the electrode assembly 10 is thermally stabled.

In a module having a plurality of rechargeable batteries, when the short-circuit tab 51 is separated from the short-circuit member 53 after external short-circuit and melting of the fuse 71 in one of the rechargeable batteries, a current flow is blocked in the entire module and thus damage to the electrode assembly 10 in other rechargeable batteries can be reduced or prevented.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and equivalents thereof.

<Description of symbols>

| | |
|---|---|
| 10: electrode assembly | 11: first electrode |
| | (positive electrode) |
| 11a, 12a: coated region | 11b, 12b: uncoated region |
| 12: second electrode | |
| (negative electrode) | |
| 13: separator | |
| 15: case | 20: cap plate |
| 21: first terminal (positive terminal) | |
| 21a, 22a: rivet terminal | |
| 21b, 22b: flange | 21d, 22d: plate terminal |
| 22; second terminal (negative terminal) | 23: short-circuit hole |
| 24: vent hole | 25: vent plate |
| 25a: notch | 27: sealing cap |
| 29: electrolyte injection opening | |
| 31, 32: positive and negative current | |
| collecting lead tabs | |
| 36: positive gasket | 37: insulation member |
| 39: negative gasket | |
| 41, 42: positive and negative insulation | |
| member | |
| 50: external short-circuit portion | 51: short-circuit tab |
| 53: short-circuit member | |
| 61, 62: first and second branch portions | |
| 63, 64. 65, 66: first, second, third, and fourth | |
| bonded portion | |
| 71: fuse | |
| 311, 312: terminal hole | 371: bottom portion |
| 372: frame portion | |
| 511, 512: first and second metal plates | |
| C1, C2: first and second gaps | W: lead tab width |

What is claimed is:

1. A rechargeable battery comprising:
an electrode assembly having a first electrode, a second electrode, and a separator between the first electrode and the second electrode;
a case housing the electrode assembly;
a cap plate coupled to an opening of the case;
a first electrode terminal in the cap plate and electrically connected with the cap plate and the first electrode;
a second electrode terminal in the cap plate, electrically insulated from the cap plate, and electrically connected to the second electrode; and
an external short-circuit portion between the second electrode terminal and the cap plate,
wherein the external short-circuit portion comprises,
a short-circuit tab connected to the second electrode terminal, and
a short-circuit member in a short-circuit hole of the cap plate, facing the short-circuit tab and configured to be bonded to or separated from the short-circuit tab according to an internal pressure, and
wherein the short-circuit tab comprises a heterogeneous metal.

2. The rechargeable battery of claim 1, wherein the heterogeneous metal of the short-circuit tab comprises:
a first metal plate, having a high thermal expansion coefficient, facing the short-circuit member; and
a second metal plate, having a low thermal expansion coefficient, facing oppositely away from the short-circuit member.

3. The rechargeable battery of claim 1, further comprising an insulation member between the short-circuit tab and the cap plate.

4. The rechargeable battery of claim 3, wherein the insulation member comprises a bottom portion supporting the short-circuit tab and a frame portion exposing the upper surface of the short-circuit tab, the frame portion protruding from the bottom portion and surrounding a side surface of the short-circuit tab.

5. The rechargeable battery of claim 4, wherein the frame portion is opened at one of its sided in a length direction of the cap plate.

6. The rechargeable battery of claim 4, wherein the short-circuit tab and the frame portion form a first gap separated therebetween in a width direction of the cap plate.

7. The rechargeable battery of claim 4, wherein the short-circuit tab and the frame portion form a second gap separated therebetween in a length direction of the cap plate.

8. The rechargeable battery of claim 1, further comprising a current collecting lead tab electrically connecting the second electrode terminal and the second electrode,
wherein the current collecting lead tab comprises a fuse having a width that is smaller than a lead tab width of the current collecting lead tab set along a width direction of the cap plate.

9. The rechargeable battery of claim 8, wherein the heterogeneous metal of the short-circuit tab comprises a first metal plate and a second metal plate, and wherein the first metal plate and the second plate of the short-circuit tab respectively have thermal expansion coefficients such that the short-circuit tab attached to the short-circuit member is separated from the short-circuit member after melting of the fuse.

10. The rechargeable battery of claim 1, wherein the heterogeneous metal of the short-circuit tab is a bi-metal.
